(19) United States
(12) Patent Application Publication
(10) Pub. No.: US 2006/0160395 A1
(43) Pub. Date: Jul. 20, 2006

(54) Methods, systems and computer program products for connecting and monitoring network equipment in a telecommunications system

(75) Inventors: Daniel W. Macauley, Fishers, IN (US); Michael G. German, Secaucus, NJ (US); Matias Peluffo, Guadalajara (ES); George Brooks, Allen, TX (US)

Correspondence Address: MYERS BIGEL SIBLEY & SAJOVEC, PO BOX 37428, RALEIGH, NC, 27627, US

(73) Assignee: CommScope Solutions Properties, LLC

(21) Appl. No.: 11/312,914

(22) Filed: Dec. 20, 2005

Related U.S. Application Data
(60) Provisional application No. 60/637,713, filed on Dec. 21, 2004.

(51) Int. Cl. H01R 13/625

(52) U.S. Cl. 439/344

(57) ABSTRACT

Methods, systems and computer program products for interconnecting network equipment with a telecommunications system includes identifying a patch panel connector port to be connected to a network equipment port, generating a work order for connecting the identified patch panel connector port to the network equipment port via a patch cord, monitoring the identified patch panel connector port to detect whether a patch cord connector has been inserted therein within a predetermined period of time, and monitoring the network equipment port for communications activity within a predetermined period of time. If a patch cord connector has not been inserted within the identified patch panel connector port within the predetermined period of time and/or if communications activity has not been detected at the network equipment port within the predetermined period of time, a technician is notified. Network equipment ports and patch panel ports are monitored for authorized and unauthorized connections.

### RELATED APPLICATION

This application claims the benefit of and priority to U.S. Provisional Patent Application No. 60/637,713 filed Dec. 21, 2004, the disclosure of which is incorporated herein by reference as if set forth in its entirety.

### FIELD OF THE INVENTION

The present invention relates generally to telecommunications systems and, more particularly, to telecommunications patching systems.

### BACKGROUND OF THE INVENTION

Many businesses have dedicated telecommunication systems that enable computers, telephones, facsimile machines and the like to communicate with each other through a private network, and to communicate with devices in remote locations via a telecommunications service provider. Conventionally, a dedicated telecommunications system is hard wired using telecommunication cables that contain conductive wire. In such hard wired systems, dedicated wires are coupled to individual service ports throughout a building, for example. The wires from the dedicated service ports conventionally extend throughout a building and into one or more telecommunications closets. The telecommunications lines from the interface hub of a main frame computer and the telecommunication lines from external telecommunication service providers may also terminate within a telecommunications closet.

A patching system is typically used to interconnect the various telecommunication lines within a telecommunications closet. In a conventional telecommunications patching system, the telecommunication lines are terminated within a telecommunications closet in an organized manner via one or more patch panels, as described below.

Referring to FIG. 1, a typical patch panel support rack 10 is shown. The rack 10 retains a plurality of patch panels 12 that are mounted to the rack 10. On each of the patch panels 12 are located port assemblies 14. The illustrated port assemblies 14 each contain six telecommunication connector ports 16 (e.g., RJ-45 ports). Other types of patch panels are known, including patch panels with optical fiber ports (e.g., SC, ST and LC ports) and 110 copper wire ports.

Each of the different telecommunication connector ports 16 is hard wired to a telecommunications line. Accordingly, each telecommunications line is terminated on a patch panel 12 in an organized manner. In small patch systems, all telecommunications lines may terminate on the patch panels of the same rack. In larger patch systems, multiple racks may be used, wherein different telecommunications lines terminate on different racks. Interconnections between the various telecommunications lines are made using patch cords 20. Both ends of a patch cord 20 are terminated with connectors 22, such as an RJ-45 or RJ-11 telecommunications connector. One end of a patch cord 20 is connected to a connector port 16 of a first telecommunications line and the opposite end of the patch cord 20 is connected to a connector port 16 of a second telecommunications line. By selectively connecting the various lines with patch cords 20, any combination of telecommunications lines can be interconnected.

In many businesses, employees are assigned their own computer network access number exchange so that the employee can interface with a main frame computer or computer network. When an employee changes office locations, it may not be desirable to provide that employee with new exchange numbers. Rather, to preserve consistency in communications, it may be preferred that the exchanges of the telecommunications ports in the employee's old office be transferred to the telecommunications ports in the employee's new office. To accomplish this task, patch cords in a telecommunication closet are rearranged so that the employee's old exchanges are now received in his/her new office.

As employees move, change positions, add or subtract lines, the patch cords in a typical telecommunications closet may require frequent rearrangement. Telecommunication patching systems that have the ability to sense a plug in a patch panel port or sense connection between two panel ports are referred to as intelligent patching systems. Intelligent patching systems are described in U.S. Pat. No. 6,222,908, which is incorporated herein by reference in its entirety.

Conventional intelligent patching systems have the capability to monitor connections between ports on patch panels. This capability is limited to “cross-connect” architectures, which connect network services to telecommunication outlets by patching between panel ports. An alternate architecture is referred to as “interconnect” architecture, which connects network services to telecommunications outlets by patching a network equipment port directly to a panel port. This interconnect architecture is deployed widely to reduce the cost and space requirements for a network infrastructure.

Unfortunately, conventional intelligent patching systems may not support interconnect architecture because of their inability to “sense” connections on ports of network equipment. One intelligent patching system, referred to as iTRACS, requires modifying network equipment using additional hardware in order to add the capability to monitor connections to a port on network equipment. Unfortunately, that approach is limited to network equipment with a low port density, which is not common in today's networks.

### SUMMARY OF THE INVENTION

In view of the above discussion, methods, systems and computer program products for interconnecting network equipment with telecommunications systems, are provided. According to some embodiments of the present invention, in order to interconnect network equipment to a telecommunications network, a patch panel connector port and network equipment port to be connected are identified. A work order that instructs a technician to connect the identified patch panel connector port to the network equipment port via a patch cord is generated. The patch cord has opposite ends and a respective connector secured to each end. One connector is configured to be removably secured within the identified patch panel port and the other connector is configured to be removably secured within the network equipment port.

According to some embodiments of the present invention, the identified patch panel connector port is monitored to detect whether a patch cord connector has been inserted therein within a predetermined period of time. If a patch cord connector has not been inserted within the identified patch panel connector port within the predetermined period of time, a technician is notified and the port may be disabled.

According to some embodiments of the present invention, the network equipment port is monitored to detect communications activity within a predetermined period of time. If communications activity has not been detected at the network equipment port within the predetermined period of time, a technician is notified and the port may be disabled.

According to some embodiments of the present invention, the work order is designated as complete in response to detecting that a patch cord connector has been inserted within the patch panel connector port and in response to detecting communications activity at the network equipment port.

Methods, systems and computer program products for monitoring telecommunications systems also are provided. According to some embodiments of the present invention, one or more ports associated with network equipment connected to a telecommunications system via a patch panel are monitored. In response to detecting a network equipment port is inactive for a predetermined period of time, the port is disabled and a technician is notified that the port has been disabled.

According to some embodiments of the present invention, patch panel connector ports are monitored for connections to unauthorized network equipment. In response to detecting unauthorized network equipment connections, the patch panel connector port connected to unauthorized network equipment is disabled and a technician is notified that the port has been disabled.

According to some embodiments of the present invention, patch panel connector ports are monitored for network equipment connected to an unauthorized connector port. In response to detecting a connection to an unauthorized port, the port is disabled and a technician is notified that the port has been disabled.

Embodiments of the present invention are advantageous because they provide connector sensing capability at network equipment ports without requiring additional hardware. Moreover, embodiments of the present invention can enable intelligent patching systems to monitor connections between patch panels and network equipment.

### BRIEF DESCRIPTION OF THE DRAWINGS

FIG. 1 is a perspective view of a typical prior art telecommunications rack assembly containing multiple patch panels with connector ports that can be selectively interconnected by patch cords.

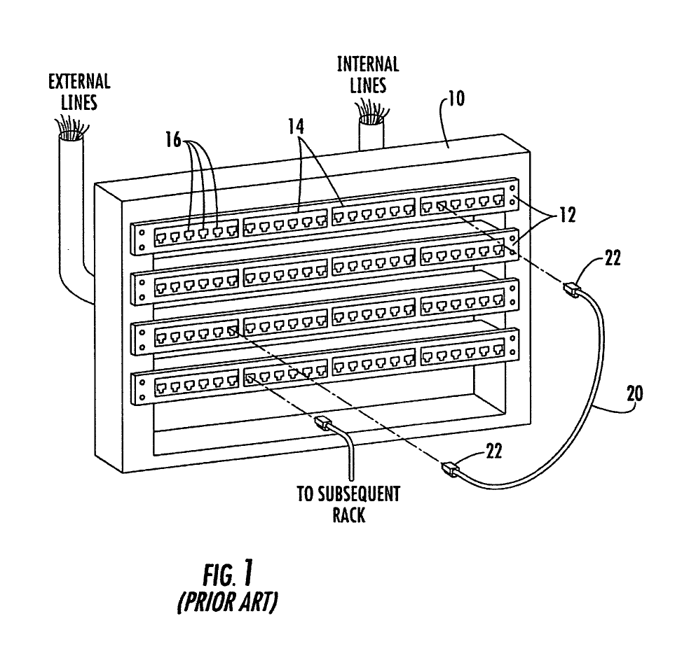

FIG. 2 is a block diagram that illustrates a software architecture for connecting network equipment to patch panels of telecommunications systems and for monitoring the connectivity of network equipment ports and patch panel ports, in accordance with some embodiments of the present invention.

FIG. 3 is a flow chart of operations for connecting network equipment to patch panels of telecommunications systems, in accordance with some embodiments of the present invention.

FIG. 4 is a flow chart of operations for monitoring the connectivity of network equipment ports and patch panel ports, in accordance with some embodiments of the present invention.

### DETAILED DESCRIPTION OF THE INVENTION

The present invention now will be described more fully hereinafter with reference to the accompanying drawings, in which illustrated embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terms “network equipment” and “network device”, as used herein, are interchangeable and refer to any device that connects to a network. This includes, but is not limited to, computers, printers, IP (Internet Protocol) telephones, hubs, switches, routers, monitoring devices, etc.

It will also be understood that, although the terms first, second, etc. may be used herein to describe various elements, these elements should not be limited by these terms. These terms are only used to distinguish one element from another. For example, a first patch panel port could be termed a second patch panel port, and, similarly, a second patch panel port could be termed a first patch panel port without departing from the teachings of the disclosure.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and devices in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computing device (such as a computer or other programmable data processing apparatus) to function in a particular manner, such that the instructions stored in the computer usable or computer-readable memory produce an article of manufacture including instructions that implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

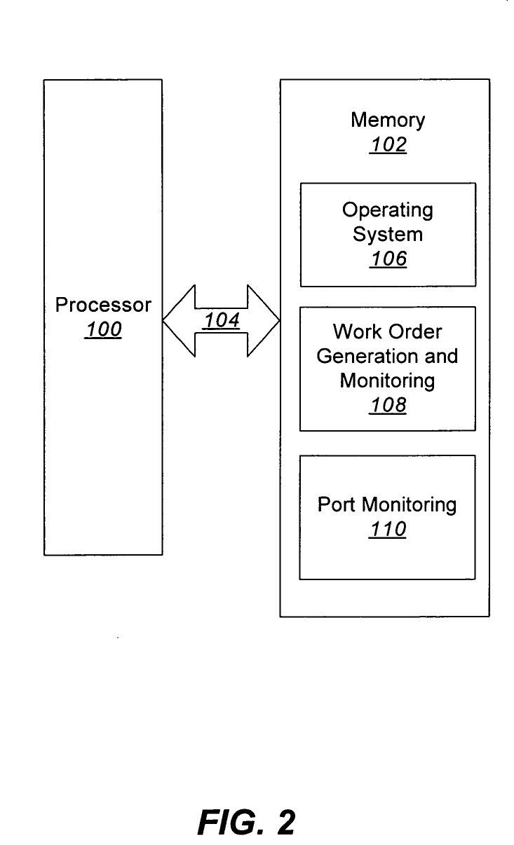

FIG. 2 illustrates a processor 100 and a memory 102 hosted by a telecommunications system device or controller that may be used in embodiments of methods, systems, and computer program products for connecting network equipment to patch panels of telecommunications systems and for monitoring the connectivity of network equipment ports and patch panel ports, according to embodiments of the present invention. For example, in some embodiments of the present invention, the processor 100 and memory 102 may be used to embody the processors and the memories used in generating work orders and monitoring implementation of existing work orders. The processor 100 communicates with the memory 102 via an address/data bus 104. The processor 100 may be, for example, a commercially available or custom microprocessor. The memory 102 is representative of the overall hierarchy of memory devices containing the software and data used to generate work orders and monitor implementation of existing work orders, in accordance with some embodiments of the present invention. The memory 102 may include, but is not limited to, the following types of devices: cache, ROM, PROM, EPROM, EEPROM, flash, SRAM, and DRAM.

As shown in FIG. 2, the memory 102 may hold three or more major categories of software and data: an operating system 106, a work order generation and monitoring module 108, and a port monitoring module 110. The operating system 106 controls operations of the telecommunications system host device. In particular, the operating system 106 may manage the host device's resources and may coordinate execution of programs by the processor 100.

The work order generation and monitoring module 108 comprises logic for creating, monitoring and documenting electronic work orders for interconnect architectures. When a system administrator selects a service to be provided to a telecommunications outlet, the present invention determines which port on the network equipment should be connected to the appropriate panel port. An electronic work order is created and sent to intelligent patching equipment for implementation.

According to embodiments of the present invention, the work order generation and monitoring module 108 may comprise logic for monitoring completion of electronic work orders that direct technicians to connect or disconnect an intelligent patch panel port and a network equipment port. When the system detects a plug in the intelligent patch panel port, it begins monitoring for activity on the network equipment port. Once port activity is detected, the work order is marked complete, and the connectivity information is updated to reflect the new connection. If no port activity is detected within a defined period of time, the system has the ability to generate an alert to notify the appropriate personnel (e.g., a technician, technician group, etc.) of the missing connection.

According to embodiments of the present invention, the port monitoring module 110 may comprise logic for enhancing the security of a network by monitoring connectivity of network equipment ports and automatically disabling all inactive ports. According to embodiments of the present invention, the port monitoring module 110 may comprise logic for leaving network equipment ports identified in a work order disabled until the remainder of the work order is completed. In addition, if a port does not go active within a specified period of time, the port monitoring module 110 may comprise logic for disabling the port to limit access to the network.

According to embodiments of the present invention, the port monitoring module 110 may comprise logic for monitoring the connections to a telecommunications system via a patch panel for unauthorized changes and for disabling ports associated with unauthorized changes. Authorized connections also may be monitored for activity, and ports may be automatically disabled if activity has not been detected for a specified period of time, thereby preventing unauthorized use of the equipment.

According to embodiments of the present invention, the port monitoring module 110 may comprise logic for maintaining a list of authorized network devices and for monitoring for unauthorized devices connected to a network. When an unauthorized device is detected, the port monitoring module 110 may comprise logic for disabling the appropriate network equipment port to prevent the device from gaining access to the network. The port monitoring module 110 may comprise logic for maintaining a list of authorized devices and a list of network equipment ports to which each device can connect. When an authorized device is connected to an unauthorized port, the port monitoring module 110 may comprise logic for automatically disabling the network equipment port to prevent access to a network (e.g., a data network) provided by that port.

According to embodiments of the present invention, the port monitoring module 110 may comprise logic for alerting the appropriate personnel when a port is disabled in order to protect a network.

According to embodiments of the present invention, the port monitoring module 110 may comprise logic for allowing specific network ports to be marked “critical”, and for monitoring activity on critical ports. If there is no activity on a critical port for a specified amount of time, the port monitoring module 110 comprises logic for alerting the appropriate personnel of the problem. According to embodiments of the present invention, the port monitoring module 110 may comprise logic for maintaining a back-up LAN connection that is automatically activated when a problem is detected on a critical port. In critical circuits, a network can be configured to have alternate network paths that are not active until a failure occurs on the main path. If the system detects a critical path has gone down, it can activate one of the backup paths.

Although FIG. 2 illustrates an exemplary software architecture that facilitates creating, monitoring and documenting electronic work orders for interconnect architectures, and for enhancing the security of a network by monitoring connectivity of network equipment ports, it will be understood that the present invention is not limited to such a configuration but is intended to encompass any configuration capable of carrying out the operations described herein. Embodiments of the present invention can be integrated into management software utilized by intelligent patching systems.

Computer program code for carrying out operations of devices and/or controllers discussed above with respect to FIG. 2 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

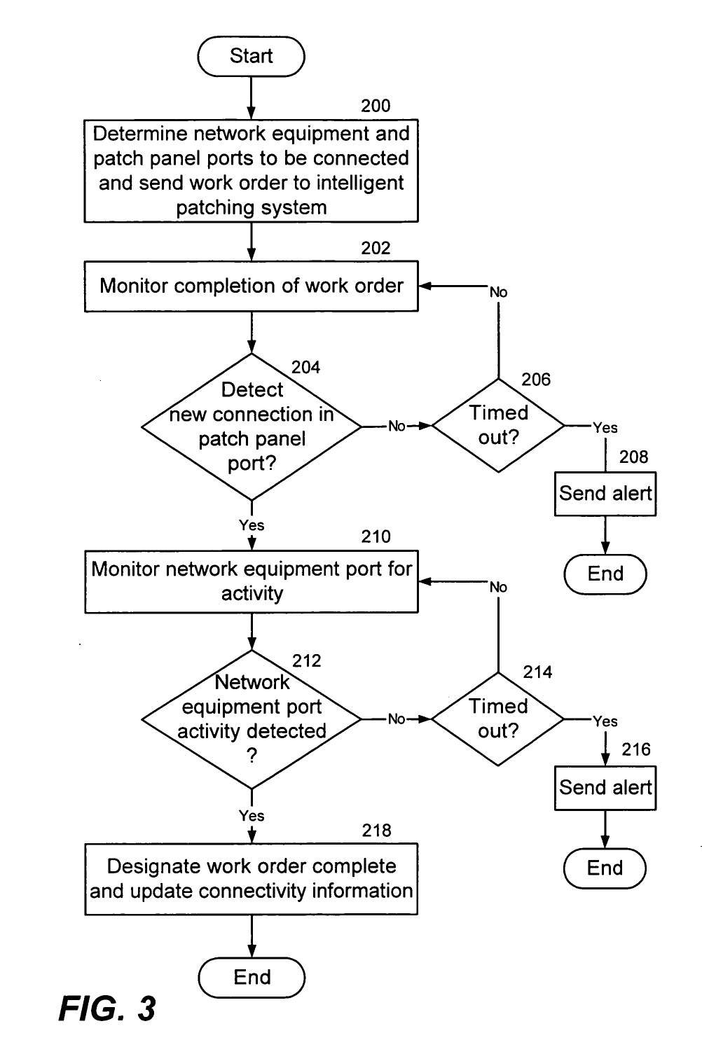

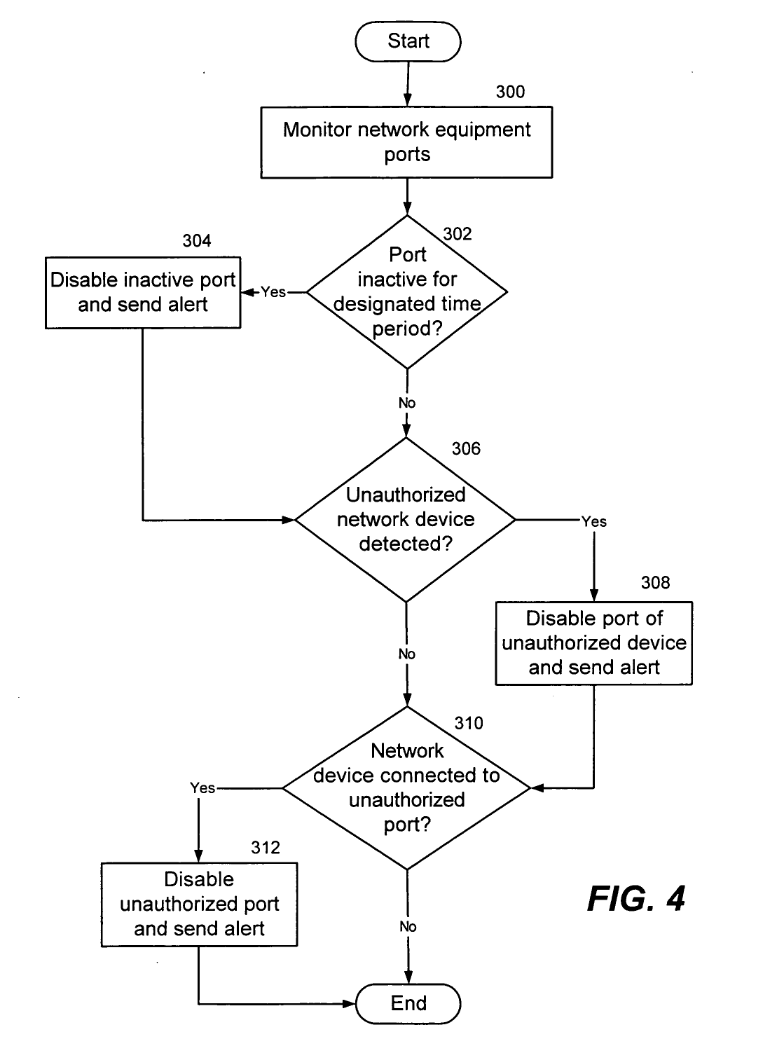

The flowcharts of FIGS. 3 and 4 illustrate the architecture, functionality, and operations of some embodiments of methods, systems, and computer program products for connecting network equipment to patch panels of telecommunications systems and for monitoring the connectivity of network equipment ports and patch panel ports. Referring to FIG. 3, in response to a network administrator selecting a telecommunications service to be provided, the work order generation and monitoring module (108, FIG. 2) determines which network equipment port is to be connected to a patch panel port, creates an electronic work order specifying the ports to be connected, and sends the electronic work order to an intelligent patching system (Block 200). Services are a reference for allowing a device to communicate to another device. Services can include connection to telephone service, access to a server, or access to a workgroup LAN, etc. Services can also be used to designate the type of medium used to communicate, (e.g., copper, fiber, single-mode, multi-mode, etc.).

The work order generation and monitoring module 108 monitors completion of the work order (i.e., have the network equipment port and patch panel port been connected via a patch cord?) (Block 202). If a new connection in the patch panel port is not detected (Block 204), a determination is made whether a predetermined time period has expired (Block 206). If the time period has expired, an alert is generated and transmitted to a technician or technician group (Block 208). If the time period has not expired, the work order generation and monitoring module 108 continues monitoring for a new connection in the patch panel (Block 202). If a new connection in the patch panel port is detected (Block 204), the work order generation and monitoring module 108 monitors the network equipment port for activity (Block 210).

If no activity is detected at the network equipment port (Block 212), a determination is made whether a predetermined time period has expired (Block 214). If the time period has expired, an alert is generated and transmitted to a technician or technician group (Block 216). If the time period has not expired, the work order generation and monitoring module 108 continues monitoring the network equipment port for activity (Block 210). If activity is detected at the network equipment port (Block 212), the work order generation and monitoring module 108 designates the work order complete and updates port connectivity information (Block 218).

Referring to FIG. 4, the port monitoring module (110, FIG. 2) monitors network equipment ports that have been activated (Block 300). If a network equipment port has been inactive for a predetermined period of time (Block 302), the port is disabled and an alert is generated and transmitted to a technician or technician group (Block 304). If an unauthorized network equipment device is detected by the port monitoring module 110 (Block 306), the port to which the unauthorized network equipment device is connected is disabled and an alert is generated and transmitted to a technician or technician group (Block 308). If a network device is detected being connected to an unauthorized network equipment port (Block 310), the port to which the network equipment device is connected is disabled and an alert is generated and transmitted to a technician or technician group (Block 312).

Many variations and modifications can be made to the preferred embodiments without substantially departing from the principles of the present invention. All such variations and modifications are intended to be included herein within the scope of the present invention, as set forth in the following claims.

That which is claimed is:

1. A method of interconnecting network equipment with a telecommunications system, wherein the telecommunications system includes a patch panel having a plurality of connector ports, the method comprising:
identifying a patch panel connector port to be connected to a network equipment port;
generating a work order that instructs a technician to connect the identified patch panel connector port to the network equipment port via a patch cord; and
monitoring the network equipment port to detect communications activity within a predetermined period of time.

2. The method of claim 1, further comprising monitoring the identified patch panel connector port to detect whether a patch cord connector has been inserted therein within a predetermined period of time.

3. The method of claim 2, further comprising notifying a technician if a patch cord connector has not been inserted within the identified patch panel connector port within the predetermined period of time.

4. The method of claim 1, further comprising notifying a technician if communications activity has not been detected at the network equipment port within the predetermined period of time.

5. The method of claim 1, further comprising:
monitoring the identified patch panel connector port to detect whether a patch cord connector has been inserted therein within a predetermined period of time;
monitoring the network equipment port to detect communications activity within a predetermined period of time; and
designating the work order complete in response to detecting that a patch cord connector has been inserted within the patch panel connector port, and in response to detecting communications activity at the network equipment port.

6. A method of monitoring a telecommunications system, wherein the telecommunications system includes a patch panel having a plurality of connector ports, the method comprising:
monitoring one or more ports associated with network equipment connected to the telecommunications system via the patch panel; and
disabling a network equipment port that is inactive for a predetermined period of time.

7. The method of claim 6, further comprising notifying a technician that a network equipment port has been disabled.

8. The method of claim 6, further comprising:
monitoring the patch panel connector ports for a connection to unauthorized network equipment; and
disabling a patch panel connector port connecting to unauthorized network equipment.

9. The method of claim 8, further comprising notifying a technician that a patch panel connector port has been disabled.

10. The method of claim 6, further comprising:
monitoring the patch panel connector ports for network equipment connected to an unauthorized connector port; and
disabling an unauthorized patch panel connector port having network equipment connected thereto.

11. The method of claim 10, further comprising notifying a technician that a patch panel connector port has been disabled.

12. A telecommunications system, comprising:
network equipment having a connector port;
a patch panel having a plurality of connector ports;
means for identifying a patch panel connector port to be connected to the network equipment port; and
means for generating a work order that instructs a technician to connect the identified patch panel connector port to the network equipment port via a patch cord, wherein the patch cord has opposite ends and a respective connector secured to each end, wherein one connector is configured to be removably secured within the identified patch panel port and the other connector is configured to be removably secured within the network equipment port.

13. The system of claim 12, further comprising means for monitoring the identified patch panel connector port to detect whether a patch cord connector has been inserted therein within a predetermined period of time.

14. The system of claim 13, further comprising means for notifying a technician if a patch cord connector has not been inserted within the identified patch panel connector port within the predetermined period of time.

15. The system of claim 12, further comprising means for monitoring the network equipment port to detect communications activity within a predetermined period of time.

16. The system of claim 15, further comprising means for notifying a technician if communications activity has not been detected at the network equipment port within the predetermined period of time.

17. The system of claim 12, further comprising:
means for monitoring the identified patch panel connector port to detect whether a patch cord connector has been inserted therein within a predetermined period of time;
means for monitoring the network equipment port to detect communications activity within a predetermined period of time; and
means for designating the work order complete in response to detecting that a patch cord connector has been inserted within the patch panel connector port, and in response to detecting communications activity at the network equipment port.

18. A system for monitoring a telecommunications system, wherein the telecommunications system includes a patch panel having a plurality of connector ports, comprising:
means for monitoring one or more ports associated with network equipment connected to the telecommunications system via the patch panel; and
means for disabling a network equipment port that is inactive for a predetermined period of time.

19. The system of claim 18, further comprising means for notifying a technician that a network equipment port has been disabled.

20. The system of claim 18, further comprising:
means for monitoring the patch panel connector ports for connection to unauthorized network equipment; and
means for disabling a patch panel connector port connecting to unauthorized network equipment.

21. The system of claim 20, further comprising means for notifying a technician that a patch panel connector port has been disabled.

22. The system of claim 18, further comprising:
means for monitoring the patch panel connector ports for network equipment connected to an unauthorized connector port; and
means for disabling an unauthorized patch panel connector port having network equipment connected thereto.

23. The system of claim 22, further comprising means for notifying a technician that a patch panel connector port has been disabled.

24. A computer program product, comprising a computer readable storage medium having computer readable program code embodied therein, the computer readable program code being configured to carry out the method of claim 1.

25. A computer program product, comprising a computer readable storage medium having computer readable program code embodied therein, the computer readable program code being configured to carry out the method of claim 6.
